(19) United States
(12) Patent Application Publication
(10) Pub. No.: US 2014/0280540 A1
(43) Pub. Date: Sep. 18, 2014

(54) SYSTEM AND METHOD FOR MANAGING CROWDSOURCED IDEA GENERATING EVENTS

(71) Applicants: Scott Hunter Wurtele, Sidney (CA); Paul Edward Wagorn, Victoria (CA); Daniel Jonathan Knopp, Whistler (CA)

(72) Inventors: Scott Hunter Wurtele, Sidney (CA); Paul Edward Wagorn, Victoria (CA); Daniel Jonathan Knopp, Whistler (CA)

(73) Assignee: IdeaConnection Ltd, Victoria, CA (US)

(21) Appl. No.: 13/827,562

(22) Filed: Mar. 14, 2013

(51) Int. Cl. H04L 29/06

(52) U.S. Cl. CPC H04L 65/403
USPC 709/204

(57) ABSTRACT

System and method of performing a crowdsourced online idea generation and peer review process for main topic of interest for a client, often involving large numbers of expert participants and a panel of expert moderators. Qualified participants are drawn from a database of system members, and moderators are often qualified client employees or consultants. A server, capable of hosting various threaded discussions on various related topics, is first initialized with various related topics, seed ideas and comments. Participants are then given access for a predetermined time, and contribute new ideas, peer review other participant's ideas, and vote ideas up and down. Moderators review progress, and vote to highlight ideas and comments, close ideas, and delete off-topic contributions. Various voting analysis algorithms draw attention to promising ideas. Participants are rewarded on a daily basis for contributing ideas, comments, and votes. The system produces new ideas that are peer reviewed and prioritized.

### BACKGROUND OF THE INVENTION

1. Field of the Invention

This invention is in the field of computerized methods to help expert groups both form and critique new ideas.

2. Description of the Related Art

Since probably the dawn of man and the initial creation of language, groups have come together to try to grapple with problems by first generating new ideas, and then critiquing these new ideas.

In today's, world, these earlier “how do we hunt that mastodon?” type problems have been replaced with even more complex problems, and the size of the groups responsible for handling these complex problems has grown by many orders of magnitude. Thus the basic problem of generating enough good ideas to overcome these more complex problems has become even more difficult.

In particular, businesses and other organizations often have difficulty looking at long-term, high value, strategic questions because their network of idea generating contacts is limited to internal staff, customers, business contacts, and other known individuals. For example, R&D expenditures in many businesses and organizations often focus primarily on incremental innovation and product development in existing business lines. Too often, longer-term industry, market, and technology trends are not considered when allocating funding for R&D. Additionally, those responsible for allocation decisions often consider a limited range of options. The results of such limited access to new ideas can be wasted resources or loss of competitiveness. Thus more structured methods of generating new ideas to complex problems are of substantial interest in the modern world.

Various structured methods of idea generation currently exist. One method, commonly called “brainstorming”, popularized by Alex Osborn in “Applied Imagination; Principles and Procedures of Creative Problem solving”, Scribner; 3^{rd} edition (1963) taught brainstorming methods. These methods generally encouraged groups to generate large numbers of ideas, and welcome unusual ideas, but also taught groups to focus on the quantity of ideas, and generally withhold criticism (e.g. peer review) of the group generated ideas.

As computer and internet technology has advanced, there has also been increased interest in finding ways to use computer technology to facilitate the idea generating process.

As one example of previous work in computer assisted idea generation, IBM Corporation has popularized a computer implemented idea management system called “ideaJam” or “Innovation Jam”. This is described in an article by Bjelland and Wood entitled “An Inside View of IBM's Innovation Jam”, MITSloan Management Review Vol. 50 (1), fall 2008, pages 32-41.

More recent publications on related computer assisted idea generation techniques are described in another paper by Stanoevska-Slabeva entitled “Enabled Innovation: Instruments and Methods of Internet-based Collaborative Innovation”, paper presented at the 1st Berlin Symposium in Internet and Society Oct. 25-27, 2011.

Internet server based threaded discussion software, allowing at least some participants to vote on the merits of various ideas, and to generate comments, are also known. Such software is used for popular websites such as Slashdot (Slashdot.com) and reddit (reddit.com).

Despite these advances, current methods in the area are still unsatisfactory. It is too easy for ideas produced by prior art methods to wander off-topic, or prematurely shut down promising avenues of approach based upon the whims of a single session facilitator. Prior art methods also tended to produce long jumbled lists of ideas that were inadequately peer reviewed and prioritized. Thus further advances in computerized methods for both generating new ideas, and rapidly evaluating these new ideas, would be desirable.

### BRIEF SUMMARY OF THE INVENTION

In one embodiment, the invention may be a computerized system and method for establishing an online collaboration system that is scalable, does not degrade in response time, and operates with a large number of experts who are allowed to access the collaboration system simultaneously.

In one embodiment, the invention may be a computer implemented system and method of performing a crowdsourced online idea generation and peer review process for a main topic of interest for a client (usually an organization such as a business, government, academic organization or think tank).

The system will generally use at least one computerized server, often a web server, and often draw upon both large numbers (often 100 to 1000) of expert participants, as well as a smaller panel of expert moderators (often between about 5 to 15 moderators). Qualified participants (e.g. participants with appropriate educational background or job experience, and who do not have conflicts) are drawn from a computer database of members. To enhance the long-term effectiveness of the idea generating process, the moderators are often selected from qualified client employees or consultants. This helps ensure that ideas produced by the invention's idea generating process are retained by the client organization on a longer term basis.

This invention's software implemented methods are generally run by a server, which in turn runs idea rally software that directs the server to host various threaded discussions on various related topics, as well as to serve pages (e.g. webpages, app pages) to the various participants and moderators allowing them to see what is going on using their respective network connected computerized devices. For any given main problem of interest, the invention's idea generating software is often first initialized with various related topics, seed ideas and comments. There are no particular time constraints on this initialization process.

Once the system is initialized, in a subsequent timed portion of the method, the participants are then given access to the server, usually for the duration of the idea generating session. The participants contribute new ideas, and peer review other participant's ideas by providing various comments. The participants also vote ideas and comments up and down. The panel of moderators concurrently review the progress of the idea generation process, and to some extent guide the idea generating process to focus on ideas of potential use to the client by voting to highlight ideas and comments that the moderators feel are particularly promising, close ideas that the moderators may feel should not be discussed further, delete off-topic contributions. The moderators may optionally also edit the participant submitted content to, for example, improve grammar so that poorly worded good ideas are not prematurely rejected.

Although the participants will often be selected for their expertise in the overall topic of interest, in a preferred embodiment, participants will not use their real names online, to better ensure that the ideas and comments are evaluated on their merits. Additionally, various automated voting analysis algorithms, which can integrate results from participant's votes and moderator's votes, can help draw attention to promising ideas. To encourage participation, in a preferred embodiment, participants are rewarded on a daily basis for contributing ideas, comments, and votes. At the end, one or more optional “best participants” can also be selected and given various rewards (e.g. best idea).

The system produces new ideas that are both peer reviewed and prioritized. In cases where the system uses a panel of moderators drawn from the client organization, rather than just a single moderator, an additional benefit is that the system also promotes discussion, interest, and enthusiasm among moderators. These moderators may then feel empowered to go and help implement promising ideas generated during the idea generation process within the client organization, even long after the timed portion of the idea generation process has finished.

### BRIEF DESCRIPTION OF THE DRAWINGS

FIG. 1 shows an overview of how the invention's Internet server based system and methods operate.

FIG. 2 shows a system help webpage informing new users about the daily participation award system used to motivate participants.

FIG. 3 shows a system Frequently Asked Questions (FAQ) webpage giving other system rules and instructions.

FIG. 4 shows a system update webpage showing a participant the various new ideas that were received since that participant last logged in.

FIG. 5A shows a system home webpage, giving an overview of the problem statement, featured ideas that the system moderators particularly like, and some of the various commands available to the participant.

FIG. 5B show another view of the system home webpage, here showing a longer list of participant submitted ideas that were not featured by the moderators.

FIG. 6 shows a moderator view of part of the threaded discussion for an idea submitted by participant Bethany, and featured by the moderators, on one way to improve crop yields. Her idea is to create plants with mutated pigment binding proteins that have enhanced absorption spectra and higher photosynthetic efficiency.

FIG. 7 shows a detail of the system's idea submission page, where participant Bethany first submitted this particular idea.

FIG. 8 shows a system page where all ideas and responses by participant Bethany can be reviewed.

FIG. 9 shows that the overall problem statement regarding methods to improve crop yields can be addressed by more than one topic. This page shows a number of moderator featured and non-featured ideas on a different approach to improve crop yields—here by developing plant hyperproducers.

FIG. 10 shows a list of moderator closed ideas. Moderators may elect to close participant submitted ideas for a variety of reasons, and not all closed ideas may be bad ideas. Indeed some closed ideas may be closed because the idea is too good, and the client wishes to continue development of that idea privately.

### DETAILED DESCRIPTION OF THE INVENTION

In one embodiment, the invention may be a computerized method of enabling a plurality of moderators to manage a plurality of qualified participants (often recognized thought leaders in their respective field) to engage in a timed, online, crowdsourced idea generation and prioritization process. Usually there will be an overall topic, which in turn may be broken down into one or more other related topics.

Here, for example, a main topic or overall topic of “how to make an improved automobile” can in turn be broken down into various related topics such as “improved engines”, “improved transmissions”, “improved streamlining” and the like.

In a preferred embodiment, the method usually operates in two major phases or portions. The first phase is an untimed (i.e. no fixed time length) setup phase or portion. The second phase or portion is a timed, idea-generation, portion where the bulk of the new idea generation and peer review actually takes place. In alternative embodiments, the second idea generation portion need not be timed, but instead can terminate using other criteria, such as when a preset number of new ideas have been submitted, upon moderator or client election, and the like.

The untimed “set up” portion of the method will often comprise obtaining a list of potential individuals (here called members). These individuals will often have a wide set of different backgrounds and qualifications. Information on these individual members, and the qualifications and background (e.g. educational history, employment history) will be stored in a crowdsource computer database, such as that shown in FIGS. 1 (100) and (102).

To do useful idea generation, which might be of value to a client, the idea generating process also needs at least a good problem statement or main topic for the idea generating process, as well as optionally additional related topics or subtopics as desired by the client or other sponsor of the idea generating process.

The invention's computerized methods are generally based on at least one computer server (104). This server will generally have at least one computer processor, memory, operating system (e.g. Linux), and appropriate ancillary software such as web server software (e.g. Apache) and other software (e.g. Perl, Python, PHP, MySQL, etc.) to run appropriate scripts and webpages as desired. The invention's various methods described herein will generally operate using (server (104) and database (102), and will transmit webpages or app screen pages over a computer network, such as the Internet to various computerized devices under control of the various participants, moderators, and administrators. These computerized devices will themselves often comprise at least one computer processor, memory, network connections, display, often a graphical user interface (GUI) type display, and web browser software or app software capable of displaying information from server (104).

In a preferred embodiment, the client or other sponsor of the idea generating process, in addition to providing the problem statement, may also provide either their own moderators (often internal company experts) or alternatively at least moderator selection criteria. The client/sponsor will also usually provide a list of criteria upon which to pick qualified participants from the member database (100). For example, a client could specify that for a particularly tough problem, it only wants PhDs who have published in a list of client approved topic areas, and who have also not worked for competitors, to serve as participants. In this case, server (104) or other computer will screen the member database (100) for these potential participants, and reject all others.

The invention's software, here designated as “idea rally” software, will often exist as a series of scripts, webpages, database queries and the like running on server (104). This idea rally software will generally be configured to accept participant and moderator provided ideas, usually uploaded from various participant and moderator computerized devices (not shown). To do this, the web server (104) may provide various webpages with suitable html forms and input sections, and the participants and moderators may fill out these forms. The information may then be returned to the server (104) using standard methods such as GET and POST methods, and the like. Alternative methods, e.g. email, SMS messages, and the like may also be used.

The server (104), running this idea rally software, will generally store these participant and moderator provided ideas and idea comments in a server database (114), and in response to queries from participants and mediators, will transmit these ideas and comments to the network connected participant and moderator computerized devices, usually in the form of formatted web pages or app screens, such as will be discussed shortly in FIGS. 4-10.

Note that because the participants are generally chosen to have expertise in the subject areas (topics) of interest, these participant comments can be viewed as essentially being a form of peer review of the various ideas submitted by other participants.

As previously discussed, in some embodiments, server (104) will be an Internet web server serving web pages or screen pages over the internet (106) to various moderator and participant computerized devices (usually as web server provided web pages or screen pages running on web browsers or app software running on these computerized devices). In other embodiments, which may be useful when higher degrees of privacy and security are desired, the computer network (106) need not be the Internet. Instead a private local area network (LAN) or other non-internet computer network may be used. In this case, server (104) may still be a server, but not an Internet server.

The idea rally software will usually also be configured to allow the moderators to initialize it with the main topic, at least one other topic, and even some initial ideas and comments. This will be done during the setup phase as well. The idea here is to “set the stage” so that when the timed portion of the idea generation process begins, the participants will not start on a completely empty playing field, but rather will encounter some initial structure to help guide subsequent ideas and discussion. This portion of the process is optional, however, and if the client or moderators wish the participants to start with a blank slate, this can be done as well.

In some embodiments, to even better “set the stage”, the moderators may in essence conduct a small beta-test of the idea generation process by inviting a group of beta test participants (usually this beta test group will be substantially smaller than main participant group) to further initialize the idea rally software with additional ideas and comments. If this beta test produces results that the moderators and client are happy with, then these beta test ideas and comments may be retained for the subsequent main idea generating session. If not, the beta test ideas and comments may be erased. This beta-testing process can continue until the moderators or client are satisfied that the system has been initialized properly.

At some point, before, during, or after the optional beta test, the moderators or system administrators will use the list of qualified participant criteria, usually provided by the client, to either manually or automatically select qualified members from the crowdsource database (100, 102). The system can be configured to then automatically electronically transmit (e.g. by email, webpage invitation, or other process) an invitation to these qualified members to participate in the main idea generation and prioritization process.

The system software may also be configured so that those qualified members who electronically accept the invitations can also be automatically accepted by the idea rally software as participants. The system may then automatically give the participants access to server (104) that is running the idea rally software. These participants will be able to participate in the idea generation process, and do various functions such as submitting their own ideas and idea comments, as well as voting on the merits of ideas and idea comments submitted by other participants. The participants may optionally also vote on the initial setup ideas and comments previously submitted by the moderators and beta test participants. Alternatively the setup ideas and comments can be distinguished from the main participant ideas and comments, and voting may be disallowed for these setup ideas and comments.

In order to ensure that participants understand how to use the idea generating system, and conduct themselves properly under the idea generating system, often server (104) and the idea rally software will often provide various rule and instructional webpages.

Examples of such rules and instructional webpages are shown in FIGS. 2 and 3. FIG. 2 shows a system help webpage informing new users about the daily participation award system used to motivate participants. FIG. 3 shows a system FAQ webpage giving other system rules and instructions.

Although the timed portion of the idea generation process may be implemented for as long or short a time period as desired by the client and moderators, or even for variable times (i.e. dependent on reaching a certain level of ideas), often time durations on the order of a week or two are preferable. Shorter periods of time tend to not allow good discussion and peer review of ideas, while longer periods of time can remove some of the sense of urgency to the project. Based upon empirical observations, the inventors have found that often time durations of around five to fourteen days are good, with periodic reviews (e.g. participation prizes, daily summaries, and the like) on a daily basis work well.

The number of participants and moderators can also, in principle, be any number between one and the population of the planet. However, again based on empirical observations, the inventors have found that having multiple moderators is useful to help promote discussion and idea exchange among moderators. It can become burdensome on the client to provide too many expert moderators, however. Based on empirical observations, it has been found that often moderator numbers between about three to about twenty moderators, such as around 5-15 moderators, or 6-10 moderators, can be a useful size. A group of moderators in this size range is of a good size to form a manageable working group that can be stimulated by ideas and comments submitted by the larger group of participants. This size group of moderators can then later become an effective lobbying force, within the client organization, at least some of these new ideas.

Because of these favorable effects, it is often desirable, at least in the case where the client is an organization, to select its own group of employees to become moderators. This way, this group of employees can become empowered by the idea generation process to continue to push for some of the ideas generated by the process, even for considerable amounts of time after the process has formally ended.

Similarly the number of participants can also vary greatly, but again based on experience, the inventors have also found that participant group sizes between about 100 to 1000 participants can be useful. Smaller numbers of participants (e.g. 10 participants) work, but don't fully utilize all of the advantages of the invention. Larger numbers of participants (e.g. 20,000+ participants) can also work, but at some point the logistics of finding organizing extremely large numbers of qualified participants, even using the invention's efficient techniques, start to exhaust the number of experts in the world that might give useful input into any given idea generating process.

Once the system setup has been completed, and the idea generation participants identified, then the timed portion of the idea generation process can begin. As before, this timed portion of the process will often also be run under server (104), which will use it's at least one processor, memory, operating system, and idea rally software to also perform the subsequent parts of the process outlined below.

In some embodiments it is useful to show participants, each time they log in to the system that day, a list of new ideas that had been submitted since the time the participant last logged in. An example of this is shown in FIG. 4. Alternatively or additionally, the “new ideas” or “active discussions” webpage can be a page that can be accessed by the participant at any time by, for an example, a link from other idea rally webpages.

To help moderators and participants keep track of the time remaining on the timed portion of the process, usually the idea rally software/server will transmit the time remaining on this timed portion to the various participant and mediator computerized devices. Often this can be done by simply updating a time remaining field on a server transmitted web browser or app screen page, such as can be seen in FIG. 5A (506).

The idea rally software will usually also be configured so that for each initial idea or participant submitted idea, the software will expose commands that allow the participants to open a threaded discussion. This threaded discussion will be used to receive subsequent participant idea comments (hopefully relevant to the idea), from various interested participants, and will also display these various participant idea comments in the context of that idea's particular threaded discussion.

In a preferred embodiment, the idea rally software is also configured to allow the participants to vote (i.e. give a positive approval vote, or a negative disapproval vote) to the various ideas and idea comments. The idea rally software can also analyze these various votes according to one or more voting analysis algorithms.

Various voting analysis algorithms are possible. Some simple algorithms will simply display the positive and negative votes on various server generated web pages or app pages, usually next to the relevant idea or comment, as is shown in FIG. 5A (508).

Other voting analysis algorithms, at least those working behind the scenes for the benefit of the moderators and client, may be more complex. Votes may, for example, be weighted differently from one voting participant to the next according to the education, experience level, past system history, or other criteria of the different participants. A participant with a history of random voting or other indicia of indiscriminate voting may have that participant's vote deweighted versus a participant with a history of more careful voting decisions.

Additionally, other factors, such as the time that the vote was cast may be used. Here for example, more recent votes, cast after a particular idea or discussion has had more time to be evaluated by other participants, may be weighted more heavily than earlier votes. Moderators may also be allowed their own vote, and depending on an adjustable parameter may also be allowed to bias the overall voting algorithm results to some extent. Additionally, the velocity of the votes may be important, with a large number of votes cast over a short period of time being given a greater or lesser weight relative to votes cast over a longer period of time.

When displaying the voting results to participants, often it is best to simply show the positive and negative votes directly on the screen so that each participant can see that his or her vote has been properly received by the system. However when displaying the voting results to moderators, it often may be useful to display the results from at least one more sophisticated voting analysis algorithms to the moderators, or possibly even the results of several different voting algorithms. Either way, the voting analysis results may often be used to visually mark or sort (e.g. by popularity) at least some of the initial ideas, and participant submitted ideas. In some embodiments, the participant idea comments may also be marked or sorted according to a voting analysis algorithm as well. This way, a highly regarded comment to a lesser regarded initial idea can obtain greater prominence.

In some embodiments, the idea rally software may also be further configured to allow the various moderators to also collectively vote, either directly into the system through the idea rally software, or via a human administrator, on various idea generation administration functions. These functions can include functions such as to highlight at least some participant ideas or comments, close at least some participant ideas, reassign the topic of at least some participant ideas, or delete at least some participant ideas or comments.

As previously discussed, FIG. 4 shows a system update webpage giving showing a participant the new ideas or active discussion threads that were received since that participant last logged in. In this example, those ideas that the moderators had voted on to highlight are shown as (400), while those ideas that the moderators have not selected to highlight are shown as (402). A number of new discussion thread responses are also shown (404).

As previously discussed, FIG. 5A shows a system home webpage, giving an overview of the problem statement (i.e. main topic statement) (500), featured (highlighted) ideas that the system moderators particularly like (501), and some of the various commands available to the participant (502), (503), (504). Note also that the system is encouraging the participants to try to utilize previous ideas and discussions to come up with new ideas. The time remaining on the timed portion of the idea generation process is also shown (506) as being three days.

FIG. 5B show another view of the system home webpage, here showing a longer list of participant submitted ideas (510) that were not featured by the moderators.

Alternatively, in some embodiments, the idea rally software may be configured so that moderators (by voting) do not directly highlight, close, reassign topic or delete ideas in comments. Instead, in these alternative configurations, the moderator votes are not automatically analyzed and applied by the system, but rather are first at least examined and affirmed by a system administrator (116). This administrator review process may, for example, be useful when inexperienced moderators initially use the system. This administrator review can then be gradually phased out, according to client wishes, as the moderators become more experienced. In still other embodiments, the administrator may simply receive a record of moderator votes, but the administrator will then initiate any such moderator recommended change.

Although moderator highlighting of various ideas and comments can be done by, for example, literally showing favored ideas or comments with an alternate colored background or font, (as is shown in FIGS. 4, 5A, 5B, 8, and 9, other methods to highlight or “feature” a favored idea or comment may also be used. The favored idea may show up as a larger font, bold font, underlined font, italic font, flashing font, boxed comment, arrow indicator, other icon, or other visual indicator. Additionally, the moderator preferred idea(s) and/or comment(s) may, for example, alternatively or additionally be moved up higher in the list of ideas as displayed on the participant's computerized device. Essentially any visual method to show that an idea is preferred may be used.

In some embodiments, it is also useful to configure the idea rally software to, while the timed portion of the idea generation process is continuing, periodically (often on a daily basis) review the status of the idea generation and prioritization process, and give feedback to encourage, sometimes direct, and also motivate the various participants. Based on empirical evidence, the inventors have found that one particularly effective motivational tool is to give out various periodic (e.g. daily) participation awards.

Various rules and algorithms can be used to assign these participant awards. As one example, the idea rally software can automatically assign participant awards based on a participant reward algorithm that takes into account voting results from other participants, and also according to moderators as well as desired. Alternatively the system may be configured to award results only based on moderator vote. As yet another alternative, the system can suggest participant rewards based on an automatic participation award algorithm, subject to ratification by the system moderators.

As one example of a participant reward algorithm, during each period (e.g. daily), the participant reward algorithm can weight that participant's own number of votes (i.e. reward participants that also helped the process by evaluating other ideas and comments via voting), that participant's number of ideas, comments, other participant's votes on the participant's ideas and comments, and moderator votes on the quality of the member's ideas and comments. The participant reward algorithm can also be designed to give heavier weight to ideas, comments and votes that were highlighted by the moderators.

The server (104) can also provide webpages or app pages to the moderators as well as the participants. Although the moderator view of the various threaded discussions may often look similar to that of an average participant's view, it need not be identical to the participant's view. In particular, such moderator webpages or app pages may provide additional moderator controls, and analysis data, that may not be provided to the participants.

FIG. 6 shows an example of a moderator view of part of the threaded discussion for an idea submitted by participant BethanyGill, and featured by the moderators, on one way to improve crop yields. Her idea is to create plants with mutated pigment binding proteins that have enhanced absorption spectra and higher photosynthetic efficiency. Here, in addition to the normal controls available to the participants, the moderator also has access to additional moderator controls (600) that allow the moderator to vote to feature or unfeature the idea (here the idea was previously featured) or even close the idea.

This example also indirectly shows the importance of having multiple moderators vote on various moderator actions, because otherwise the moderators might act inconsistently, one moderator acting to feature an idea, a second moderator acting to un-feature the same idea, a third moderator acting to close the same idea, and so on. Some of the threaded comments regarding Bethany's idea can also be seen. Here the moderator view generated by server (104) also provides an additional moderator “delete” control that allows the moderator to either directly, or via a moderator voting process, delete comments that might contain objectionable material (602).

FIG. 7 shows a detail of the system's idea submission page where, for example, participant Bethany first submitted her particular idea, which the moderators later found to be quite promising. In some embodiments, as previously discussed, the moderators or system administrators may also be given access to edit webpages where they can, for example, clean up poor grammar or otherwise tweak ideas that may be promising, but perhaps inelegantly worded.

In order to help participants keep track of their various ideas and comments, the system can also provide a participant's posting page. This page, shown in FIG. 8, provides a webpage or app screen where all ideas and responses by a given participant, in this example participant Bethany, can be reviewed. Note that her idea submission, previously shown being generated in FIG. 7, was subsequently favorably voted upon by the moderators and is here shown highlighted as well (800).

FIG. 9 shows that the overall problem statement regarding methods to improve crop yields can be addressed by more than one topic. This page shows a number of moderator featured and non-featured ideas on a different approach (topic) to improve crop yields—here by developing plant hyperproducers.

This cycle of participant idea submissions and comments can then continue until the time is exhausted on the timed portion of the process, or other “end” criteria (preset number of new ideas, or even submission of an idea that the moderators consider incredibly great, etc.) is reached.

Often it is further useful to configure the idea rally software so that, upon completion of the timed portion of the process, the idea rally software then prompts the moderators to vote on at least one best participant award. Such a step can be useful to further motivate the various participants. To help in this process, the idea rally software (as executed by server 104) can, for example, provide a list of the various participant submitted (crowdsourced) ideas, participant submitted idea comments, and the participant voting results (e.g. crowdsourced idea prioritization) as determined by various participant positive or negative votes and various voting algorithms as previously discussed. Additionally, the idea rally software may be configured to consider other criteria as well. These other criteria can include the amount of comments generated by a particular idea, the rate at which comments to a particular idea accumulated, or number or quality of various daughter ideas spawned by the participant's various ideas and comments.

In some embodiments, the idea rally software may be further configured to allow the moderators to override the system's automatically generated recommendations and substitute their own judgment, or the client's judgment, as desired.

To help facilitate an accurate participant reward process, in some embodiments, the idea rally software may be configured so that when a participant submits a new idea, the system may also allow that new idea submitting participant to electronically credit one or more older ideas or comments (often from other participants) as having help inspire the new idea. In these embodiments, the number of new ideas that credit earlier ideas can thus be used to help influence participant rewards, and/or help improve the score of various credited participant submitted ideas.

To keep participants motivated and up to date in the discussions, in some embodiments, it may also be useful to configure the idea rally software to electronically notify (e.g. by email, SMS message, webpage, and the like) a specified participant whenever another participant submits an idea comment or a related idea to an idea submitted by said specified participant.

### Additional Features:

As previously discussed, often it will also be useful to configure the idea rally software to electronically notify each participant, on a periodic basis, of new ideas submitted during that period of time and those participants that received participation rewards during that period of time. This again can be done by email, SMS, newsletter, webpage, or other methods.

The idea rally software may also be configured to enable the moderators (or system administrators) to post individual or group messages to the various participants and other moderators.

Also, as previously discussed, in some embodiments, it is useful to configure the idea rally software so that the various ideas may be sorted and viewed by the participants and moderators (when displayed on their respective computerized devices), according to such categories as “topic”, “all ideas”, “new ideas” (e.g. since that participant's last login), “moderator highlighted idea”, “ideas with new idea comments”, “moderator closed ideas”, and the like.

FIG. 10 shows a list of moderator closed ideas. Moderators may elect to close participant submitted ideas for a variety of reasons, and not all closed ideas may be bad ideas.

The idea rally software may also be configured to sort the ideas by various algorithm scores, such as the various voting algorithms (previously discussed). This may be particularly useful for the moderators, since here the ideas may be sorted according to more sophisticated voting algorithms that might not normally be made available to participants. Such sorting by algorithm score can help the moderators quickly see potentially promising ideas.

Although in some embodiments, the participants optionally may be shown ideas sorted by more sophisticated voting algorithm scores as well, in some cases this may be less preferred, because it could potentially make it easier for participants to “game” the system.

To assist in evaluation of various ideas and comments, in some embodiments, the idea rally software may also be configured to scan the various ideas and comments for a plurality of moderator selected key words, and further visibly mark ideas and comments containing these key words when these ideas and comments are displayed on the moderator computerized devices. Such automated scanning can also be done using various moderator or system selected key words to also detect and flag bad language, unwanted references to competitors, and the like.

Since, in some embodiments, the idea rally software is intended to synthesize input from a number of different moderators, often it will be useful to configure the idea rally software to further provide moderator web pages or app pages that enable the moderators (who may be in very different geographic locations) to privately collaborate and work together as a group to discuss each individual moderator's assessment of said ideas and comments. These moderator web pages or app pages can further be used to allow the individual moderators to vote on their individual assessment or rankings of the various ideas and comments.

In some embodiments, it may be desirable to further configure the idea rally software to block “lurkers”—that is invited participants who are logging in, but otherwise not contributing to the process, from further access to the system. This can either be done by giving various warnings to the lurking participants prior to banning further access, or can be done without warning as per moderator, client, or administrator election. Thus in this embodiment, the idea rally software may automatically block further “lurking” participant access to the idea rally software during the timed portion of the idea rally process to those participants that have a timed portion participation history that falls below a preset threshold (e.g. at least one vote or comment over a period of several days, or over several participant logins).

### Further Discussion and Examples

In other embodiments, the invention may be viewed as a method to develop an online collaboration system that can be simultaneously accessed by various participants and members world-wide, enabling online dialogue without degrading response time. This method may either be a secure method run under higher levels of security and require appropriate nondisclosure agreements, or the method may be an open method.

On a commercial level, once the invention's software and systems are in place, the owners of the system may then negotiate and sign agreements with various clients to run one or more idea generating sessions. Here, it will be useful to define various idea generating parameters, such as the key focus or goal of the idea generating process, if the process is to be run on a confidential (i.e. identity of the Client is to be withheld from participants) or non-confidential basis, duration of the event (typically 7 days), number and type of moderators to be engaged, whether the Client wishes to do designate some of its own employees or consultants as moderators, as well as moderators or participants to be excluded from the idea generating process. Other points to establish include the numbers and amounts of any daily or final incentive prizes, criteria for awarding daily or final incentive prizes, and important topics and subtopics to initially seed the idea generating process.

Generally, the invention's method will use an automated computer-based system, such as server (104) to recruit members and potential participants. These members and potential participants may be topic-related thought leaders from many locations throughout the world. The recruitment process can use a wide range of approaches, such websites, professional associations, ads through the Internet or other media, universities, and mailing lists. Additionally, such recruitment can also be supplemented by referrals from known thought leaders and/or previously enrolled system members from the applicable industry or discipline. The client may also, if it wishes, identify some of its employees or consultants who may also participate in the idea generating process, either openly or anonymously.

As previously discussed, the system may use a computer software filter, often run on server (104) to scan member database (100), to optionally identify and remove from further consideration, those member thought leader applicants who are employed by the Client's competitors. This filter can also include employees of the Client if the Client so wishes.

The potential participants can thus be drawn from member database (100), and will generally be selected according to their area of expertise (education, training, skills, specialized knowledge, area of residence, published visionary articles and books) and other pre-established criteria. Here, often the goal is to find participants who are key thought leaders in their field of endeavor, and possess the required expertise to engage in high-level dialogues related to the topics under consideration.

The invention's methods will generally use idea rally software, often running on server (104), to notify each selected potential participant selected from member database (100). If confidentiality is desired, the system will usually require these participants to sign a confidentiality agreement (often online) covering their participation in the intention's idea generating process. The system can also optionally send timely reminders to those who have not yet signed and as desired remove from the selected participant list those potential participants who have not signed any required nondisclosure agreements. In some embodiments, intellectual property ownership transfer agreements (e.g. from the participants to the client organization) may also be required.

Various types of agreements are possible. For example, one type of agreement might include a provision that the Client will be entitled to unrestricted, non-exclusive, royalty free rights to use any ideas, concepts, or other information contributed to the Intention's idea generating process, and that the participant will ensure that contributions during the idea generating process will not include the Intellectual Property of others unless specifically so attributed. Other types of agreement are also possible.

Again, using a confidential idea generating process as a specific example, here the method's software, often running on server (104) will select members who have signed the online confidentiality agreement from database (100), and advise them that they have been authorized to participate in the idea generating process. The system may also give them an overview of the various topic areas, and advise the participants that they have a chance of making a major impact on a strategic question. The system may also optionally advise them about other benefits of participation, such as an optional baseline participation fee, and/or an ability to also win prizes based on various factors such as participation (e.g. submitting ideas, commenting on others ideas, voting) and quality of ideas (often as judged by a combination of moderator voting and voting patterns of other participants).

The participants will also often be given access to a server (104) provided URL (e.g. website) for the idea generating process. The system will also provide information pertaining to the rules of engagement for that particular event (e.g. see FIGS. 2 and 3). These rules can include various provisions such as that active participation is required to remain in the idea generating process, role of moderator, peer review process, IP provisions, process for branching into subtopics), start time and date and end time and date of the Idea generating process, and confirmation of the prizes available for best daily participation and best overall contribution.

In some embodiments, the participants may be asked by the invention's idea rally software, often at the time when they are notified they have been selected, to provide or identify a participant system name that is different from the participant's real name. This allows participant identities to be kept confidential from at least the other participants, if this is so desired. This can be helpful in flushing out ideas because, for example, other participants may tend to be overly deferential to a well-known participant. By contrast, use of alternate names allows all ideas to be evaluated on their merits, rather than on the identity of the participant. The system itself will keep track of the real identities of the participants in database (100).

The system will also maintain a database of qualified moderators or facilitators. These may either be provided by the client, or alternatively may be drawn from the member/participant database (100) as well, here usually employing higher levels of screening for experience and training.

As shown in FIG. 5A (500), the overall topic of that particular idea generating session will often be briefly described, on the site home page, along with various related topics (502). These subtopics may be provided by the client, or alternatively generated during the previously described initial idea seeding process.

Generally a separate dialogue (e.g. threaded discussion) is created for each such topic. These threaded discussions cumulatively record the dialogue among various participants during the idea generating process. If the client has prioritized the topics, then these topics may be listed in this order. Alternatively the topics may be listed in the order of most contributions, most recent activity, or other order. During the idea generating process, the participants may also suggest or even vote upon adding additional topics to this list.

As previously shown in FIG. 6, and as discussed elsewhere, the system typically records the input of the participants during the idea generating process dialogue as various threaded comments. Generally the software supports multiple levels of comment nesting. In some embodiments, the system can allow this dialog to take place in real time. Real time dialog can be useful, because it can be lively and as close to a live conversation as possible. For example, a question can be posed, and multiple participants can respond to the question at the same time. Their input will be recorded in the system according to the time they press “send”.

As previously discussed, the various participants may indicate to the system, either by default, or at their discretion if they wish to be notified (e.g. by email or other electronic message sending process), when a new contribution has been made by another participant on any of the subtopics they are interested in participating in, or on their own previous contributions. The participants may optionally also elect various different types of update frequencies—e.g. per each new contribution, daily, hourly, every 2, 4, 6, 8 12 hours, and so on.

As previously discussed, and as shown in FIG. 4, to simplify use, the system can also optionally show participants a list of new ideas or comments made on the system since that participant had last signed onto the system (e.g. signed on to server 104). Additionally, in some embodiments, the system may also include a link in the sidebar for new discussions (FIG. 5A, 504), which may link to a server provided webpage that lists ideas with comments added since the participant's last visit. The system may optionally also highlight those new comments when they view one of those ideas.

As previously discussed, the system can additionally contain a link, such as a sidebar link, to allow the participant to examine a webpage with their own contributions. This is shown in FIG. 8. This webpage can optionally have links or hotlinks to the responses of other participant's to that particular participant's idea or comment. Optionally, the participant may elect to view only ideas and responses submitted within a particular time span, such as the last two days.

In some embodiments the client may assign either their own moderators (or representatives to work with a system supplied moderator), to actively review the participant dialogue as it progresses. These moderators, (supplemented by client input per the client's wishes) may perform various activities such as:

a) Assign new topics to participant contributed ideas that may warrant their topic, thus ensuring that the idea gets its own separate dialogue
b) Highlight (e.g. by use of colors, fonts, arrows, or other indicia) participant ideas and comments which the moderators determine (either by moderator vote, or according to the judgment of a particular moderator in charge of that section) are of special interest. The moderator may also choose to move such highlighted ideas or comments to the top of the list of (as displayed on the relevant webpage).
c) Close and archive various topics or ideas from further dialogue if the dialogue if the moderator/client determines that this topic or idea is not productive, or is duplicative, or sensitive (e.g. perhaps the client is already aware of the idea and is secretly working on it). Such closed ideas can, in some embodiments, be viewed in a “closed ideas” webpage, but they cannot be otherwise voted on or commented on further.
d) Identify interesting contributed ideas which might usefully be listed under more than one topic.
e) Edit the participant's contributions. A good idea can often be ignored if it contains misspellings or poor grammar, and here a moderator's edits can help rescue an otherwise good idea that might be overlooked for trivial reasons. Additionally, the moderator can also pose questions back to the idea participant and suggest that further clarification might be useful, or delete inappropriate or off-topic ideas and comments.

As previously discussed, the system software will usually also contain provisions to enable a voting type peer review process. This voting type peer review can allow the participants to vote ideas or comments up or down in rank order. To help facilitate review, it is often also useful to configure the server and web page software to display the higher rated (e.g. more positive votes) comments first, along with their associated threaded comments.

Generally, in a default configuration, the highest rated idea will often be at least initially displayed first (i.e. at the top of the webpage). However the system software can also give the user to sort the comments in other orders, such as the most recent, the most commented on, most controversial (i.e. total number of positive and negative votes), and so on.

The inventors have found by direct experimentation that to energize the contributors, often it is useful to award daily prizes (usually at the end of the day) for those participants that contributed the most that day. Here “contribution” can be a function of ideas and comments that received the most positive peer votes, voting activity (here often supplemented by some sort of algorithm that detects if the voting activity follows a pattern indicative of automatic user behavior, rather than intelligent user behavior). The daily prizes can be of various sorts, ranging from recognition, non-financial items, or financial items such as daily cash prizes.

Often, to motivate the other participants, it is desirable to further configure the system, often through server (104) to send out daily announcements (e.g. updates) either by webpage, email, electronic newsletter and the like giving information about the daily awards, and the overall status of that idea generating session. This daily update, which can be automatically generated by server (104), can report on new topics, closed topics, most liked (highest voted) ideas, most controversial ideas (i.e. higher numbers of both positive and negative votes), trending ideas (ideas with the most comments) time remaining on the idea generation event, and the like. The purpose of this daily update is to motivate the participants to continue to contribute to the process.

Often also on a daily basis, the system may, either automatically or manually, generate repots for the moderator and client that analyzes the contributions by the various participants. This report, for example may flag unusually active participants, unusually inactive participants, participants with an unusually high level of moderator deleted comments, participants with an unusually high level of positive or negative votes, and so on. Those participants that may be overly inactive or causing problems may be sent advisory messages, and or blocked from further system access as per client and moderator preferences.

Once the idea generating process has completed (i.e. reached the end of its stated time), often it is then useful to have the moderators review the various participant ideas, and award one or more grand prizes for those ideas that pass a grand prize algorithm or criteria. Such grand prize algorithms or criteria may evaluate an idea, for example, by a function of number of positive votes from other participants, as well as a function of moderator votes or client votes. Generally if the client votes, the client vote will be considered decisive, or at least given a very high weight in the ultimate decision.

Additionally, upon completion, the system software, again often running on server (104), can also be configured to either automatically or manually generate a wrap-up report for the client and moderator, as well as for the system administrator. This wrap-up report can include summary metrics related to participation by the various participants, a summary of the key ideas contributed as identified by the peer review process, and often a listing of all ideas and comments which were contributed during the idea generating process.

The system may then further, either automatically or manually, at the end of the process send an electronic survey, (such as a multiple choice survey with additional fields for text comments) to all participants inviting their evaluation of the idea generating process, as well as soliciting suggestions for improvement.

In other embodiments, server (104) may also create persistent or static webpages to summarize the idea generating process and the prizes awarded. Here various types of versions may be published, such as versions accessible by the general public, versions accessible by the participants, and versions accessible by the client (which may contain confidential content).

The basic idea generating process discussed here can be further altered or customized according to administrator or client preference. Such customizations include use of alternative algorithms to process voting and determine subsequent ratings or results, various security levels, webpage customization (i.e. use of client logos or not, use of embedded videos, use of live audio or video conferencing, use of webinars and supplemental documents, and the like).

Thus in summary, the invention can provide organizations with an online conversation with hundreds, or even thousands, of experts and professionals, in multiple disciplines, who are willing to share their knowledge and expertise. These outside experts provide useful perspectives that may not be available from internal sources. The key insights generated by the process can be used to guide strategic decisions which impact long-term growth and revenue streams, and even the organization's very survival.

Unlike other crowdsourcing approaches the intention's idea generating process finds experts external to the organization to participate in discussions about key questions related to strategic issues. The process is highly scalable so a very large number of carefully chosen experts from many disciplines can participate in the dialogue.

In other embodiments, the invention may also be viewed as being a low cost method of tapping into the most knowledgeable and accomplished experts in the world. The invention's computerized methods avoid the need for organizing large in-person conferences to discuss strategic questions. As a result, there is a greater likelihood of world class experts participating because it does not entail travel and several days of dedicated time. Instead, participants in the invention's idea generating process can participate within the time restrictions they face from their existing jobs and activities.

The one or more moderators can delete spam and off-topic ideas and discussions, and also act as a catalyst to promote further in-depth discussion around various interesting ideas that have been provided. In a preferred embodiment, the client organization may allow its own employees to participate in the dialogue as moderators, and to highlight ideas that merit more in-depth discussion among the experts. Key questions can be discussed and fine-tuned as the discussion progresses, thereby enabling in-depth dialogue.

Among other useful output, the invention can produce: useful new and innovative ideas, concepts, models, and long-term visions, and strategic directions for further consideration, such as long-term R&D expenditures.

1. A computerized method of enabling a plurality of moderators to manage a plurality of qualified participants engaged in a timed, online, multi-topic, crowdsourced idea generation and priorization process, said method comprising a timed portion and an untimed portion, said untimed portion comprising:
storing data pertaining to the qualifications of a plurality of members in a crowdsource computer database;
providing a problem statement, list of moderators, and list of qualified participant criteria;
providing at least one server with idea rally software configured to accept participant and moderator provided ideas and idea comments from network connected participant and moderator computerized devices, store said participant and moderator provided ideas and comments in a server database, and in response to queries from said participants and mediators transmit said ideas and comments to said network connected participant and moderator computerized devices;
wherein said idea rally software is configured to allow said moderators to initialize said idea rally software with initial topics and initial ideas relevant to said problem statement;
using said list of qualified participant criteria to automatically select qualified members from said crowdsource database, and electronically transmit an invitation to said qualified members to participate in said idea generation and priorization process;
wherein those qualified members that electronically accept said invitations are accepted by said idea rally software as participants, said participants further being given access to said idea rally software for the purpose of submitting ideas and idea comments;
using at least one computer processor on said server to start and run said timed portion, said timed portion further comprising:
transmitting the time remaining on said timed portion to said participant and mediator computerized devices;
for each initial idea or participant submitted idea, opening a threaded discussion, receiving subsequent participant idea comments, and displaying said participant idea comments in said threaded discussion;
wherein said idea rally software is further configured to allow said participants to provide a positive or negative vote on said initial ideas, participant submitted ideas, and said participant idea comments, and to analyze said votes according to a voting analysis algorithm;
using said voting analysis algorithm to visually mark at least some of said initial ideas, participant submitted ideas, and said participant idea comments according to said vote;
wherein said idea rally software is further configured to allow said plurality of moderators to further moderator vote to either highlight at least some participant ideas or comments, close at least some participant ideas, reassign the topic of at least some participant ideas, or delete at least some participant ideas or comments;
using said idea rally software to, over said timed process, periodically review the status of said idea generation and prioritization process, and using a participant reward algorithm to determine which participants should receive participation rewards;
wherein, upon completion of said timed portion, said idea rally software is further configured to allow said moderators to further moderator vote on at least one best participant award;
and using said idea rally software to provide a list of crowdsourced ideas, crowdsourced idea comments, and crowdsourced idea priorization as determined by said positive or negative votes.

2. The method of claim 1, wherein for each participant during said period, said participant reward algorithm weights that participant's own number of votes, said participant's number of comments, other participant's votes on said participant's ideas and comments, and moderator votes on the quality of said member's ideas and comments.

3. The method of claim 1, further using said idea rally software to electronically notify a specified participant whenever another participant submits an idea comment to an idea submitted by said specified participant.

4. The method of claim 1, further using said idea rally software to electronically notify each participant, on a periodic basis, of new ideas submitted during that period of time and those participants that received participation rewards during that period of time.

5. The method of claim 1, wherein said moderators may further use said idea rally software to post group messages to said participants.

6. The method of claim 1, wherein after said moderators initialize said idea rally software with initial topics and initial ideas relevant to said problem statement, further utilizing a group of initialization participants to further initialize said idea rally software with at least initial idea comments.

7. The method of claim 1, wherein said ideas may be sorted and viewed by the participants and moderators, when displayed on their respective computerized devices, according to topic, all ideas, new ideas, moderator highlighted ideas, ideas with new idea comments, and moderator closed ideas.

8. The method of claim 1, wherein said idea rally software is further configured to scan said ideas and comments for a plurality of moderator selected key words, and further visibly mark ideas and comments containing said key words when said ideas and comments are displayed on said moderator computerized devices.

9. The method of claim 1, wherein said idea rally software further provides moderator web pages or app pages configured to enable said moderators to work privately as a group to discuss each individual moderator's assessment of said ideas and comments, and vote on each individual moderator's rankings of said ideas and comments.

10. The method of claim 1, wherein said idea rally software automatically blocks access to said idea rally software during said timed portion to those participants that have a timed portion participation history that falls below a preset threshold.

11. The method of claim 1, wherein the timed portion of said method comprises five to fourteen days, and wherein the periodic review is a daily periodic review; and
wherein said plurality of moderators comprises three to twenty moderators, and said plurality of participants comprises 100 to 1,000 participants.

12. The method of claim 1, wherein said server is an internet web server serving web pages or screen pages, said moderator and participant computerized devices are internet connected computerized devices configured to display said web server provided web pages or screen pages on web browsers or app software running on said computerized devices.

13. A computerized method of enabling a plurality of moderators to manage a plurality of qualified participants engaged in a timed, online, multi-topic, crowdsourced idea generation and priorization process, said method comprising a timed portion and an untimed portion, said untimed portion comprising:
storing data pertaining to the qualifications of a plurality of members in a crowdsource computer database;
providing a problem statement, list of moderators, and list of qualified participant criteria;
providing at least one server with idea rally software configured to accept participant and moderator provided ideas and idea comments from network connected participant and moderator computerized devices, store said participant and moderator provided ideas and comments in a server database, and in response to queries from said participants and mediators transmit said ideas and comments to said network connected participant and moderator computerized devices;
wherein said idea rally software is configured to allow said moderators to initialize said idea rally software with initial topics and initial ideas relevant to said problem statement;
using said list of qualified participant criteria to automatically select qualified members from said crowdsource database, and electronically transmit an invitation to said qualified members to participate in said idea generation and priorization process;
wherein those qualified members that electronically accept said invitations are accepted by said idea rally software as participants, said participants further being given access to said idea rally software for the purpose of submitting ideas and idea comments;
using at least one computer processor on said server to start and run said timed portion, said timed portion further comprising:
transmitting the time remaining on said timed portion to said participant and mediator computerized devices;
for each initial idea or participant submitted idea, opening a threaded discussion, receiving subsequent participant idea comments, and displaying said participant idea comments in said threaded discussion;
further using said idea rally software to electronically notify a specified participant whenever another participant submits an idea comment to an idea submitted by said specified participant;
wherein said ideas may be sorted and viewed by the participants and moderators, when displayed on their respective computerized devices, according to topic, all ideas, new ideas, moderator highlighted ideas, ideas with new idea comments, and moderator closed ideas;
wherein said idea rally software is further configured to allow said participants to provide a positive or negative vote on said initial ideas, participant submitted ideas, and said participant idea comments, and to analyze said votes according to a voting analysis algorithm;
using said voting analysis algorithm to visually mark at least some of said initial ideas, participant submitted ideas, and said participant idea comments according to said vote;
wherein said idea rally software is further configured to allow said plurality of moderators to further moderator vote to either highlight at least some participant ideas or comments, close at least some participant ideas, reassign the topic of at least some participant ideas, or delete at least some participant ideas or comments;
using said idea rally software to, over said timed process, periodically review the status of said idea generation and prioritization process, and using a participant reward algorithm to determine which participants should receive participation rewards;
wherein said moderators may further use said idea rally software to post group messages to said participants;
further using said idea rally software to electronically notify each participant, on a periodic basis, of new ideas submitted during that period of time and those participants that received participation rewards during that period of time;
wherein said server is an internet web server serving web pages or screen pages, said moderator and participant computerized devices are internet connected computerized devices configured to display said web server provided web pages or screen pages on web browsers or app software running on said computerized devices;
wherein, upon completion of said timed portion, said idea rally software is further configured to allow said moderators to further moderator vote on at least one best participant award;
and using said idea rally software to provide a list of crowdsourced ideas, crowdsourced idea comments, and crowdsourced idea priorization as determined by said positive or negative votes.

14. The method of claim 13, wherein for each participant during said period, said participant reward algorithm weights that participant's own number of votes, said participant's number of comments, other participant's votes on said participant's ideas and comments, and moderator votes on the quality of said member's ideas and comments.

15. The method of claim 13, wherein after said moderators initialize said idea rally software with initial topics and initial ideas relevant to said problem statement, further utilizing a group of initialization participants to further initialize said idea rally software with at least initial idea comments.

16. The method of claim 13, wherein said idea rally software is further configured to scan said ideas and comments for a plurality of moderator selected key words, and further visibly mark ideas and comments containing said key words when said ideas and comments are displayed on said moderator computerized devices.

17. The method of claim 13, wherein said idea rally software further provides moderator web pages or app pages configured to enable said moderators to work privately as a group to discuss each individual moderator's assessment of said ideas and comments, and vote on each individual moderator's rankings of said ideas and comments.

18. The method of claim 13, wherein the timed portion of said method comprises five to fourteen days, and wherein the periodic review is a daily periodic review; and
wherein said plurality of moderators comprises three to twenty moderators, and said plurality of participants comprises 100 to 1,000 participants.
